(19) United States
(12) Patent Application Publication
(10) Pub. No.: US 2011/0140891 A1
(43) Pub. Date: Jun. 16, 2011

(54) Electrode for an Occupant Sensing System Having Fault Detection and Method of Operating the Same

(75) Inventors: Duane D. Fortune, Lebanon, IN (US); Robert K. Constable, Kokomo, IN (US); Mark C. Hansen, Kokomo, IN (US); Mohamad R. Jaraki, Grosse Pointe Woods, MI (US)

(73) Assignee: DELPHI TECHNOLOGIES, INC., Troy, MI (US)

(21) Appl. No.: 12/636,835

(22) Filed: Dec. 14, 2009

(51) Int. Cl. G08B 13/00; G08B 21/00

(52) U.S. Cl. 340/541; 340/635

(57) ABSTRACT

An electrode formed of electrically conductive material and configured for use in an occupant sensing system. The electrode includes an antenna portion and a diagnostic portion. The antenna portion is configured to provide an electrical impedance indicative of an occupant presence. The diagnostic loop portion is configured to provide an electrical conductivity indicative of a condition of the electrode.

### TECHNICAL FIELD OF INVENTION

The present invention generally relates to occupant sensing systems, and more particularly relates to diagnosing faults in occupant sensing systems that measure electrical impedance of an electrode to determine the presence of an occupant.

### BACKGROUND OF INVENTION

It has been proposed to place an electrode formed of electrically conductive material in a vehicle seat as a sensor for detecting the presence of an occupant in the seat. For example, U.S. Patent Application Publication No. 2009/0267622, which is hereby incorporated herein by reference, describes an occupant detector for a vehicle seat assembly that includes an occupant sensing circuit that measures the impedance of an electric field generated by applying an electric signal to the sensor in the seat. The presence of an occupant affects the electric impedance of the sensor that is measured by the occupant sensing circuit. Because of the sensitivity of the measurements required for accurate occupant sensing, it is typically necessary that the electrode have consistent electrical characteristics. However, when the electrode is damaged due to extended use or abuse, or when the occupant shifts position in the seat, the electrode may be flexed in such a way as to damage the electrically conductive material forming the electrode. It has been determined that certain types of damage, such as fatigue fractures in the electrically conductive material, may reduce occupant sensing accuracy. What is needed is a way to detect damage to the electrode and thereby determine the condition of the electrode.

### SUMMARY OF THE INVENTION

In accordance with one aspect of this invention, an electrode that is formed of electrically conductive material and is configured for use in an occupant sensing system is provided. The electrode includes an antenna portion and a diagnostic portion. The antenna portion is configured to provide an electrical impedance indicative of an occupant presence. The diagnostic loop portion is configured to provide an electrical conductivity indicative of a condition of the electrode.

In another aspect, an occupant sensing system having fault detection including an electrode and a controller is provided. The electrode is formed of electrically conductive material for sensing an occupant presence proximate to the electrode. The electrode includes an antenna portion and a diagnostic loop portion. The antenna portion is configured to provide an electrical impedance indicative of the occupant presence. The diagnostic loop portion is configured to provide an electrical conductivity indicative of a condition of the electrode. A controller is coupled to the electrode and is configured to measure the electrical impedance and the electrical conductivity. The controller determines the occupant presence based on the electrical impedance, and determines the condition of the electrode based on the electrical conductivity.

In another aspect, a method of detecting a fault in an occupant sensing system is provided. The system includes an electrode formed of electrically conductive material that is configured to provide an electrical impedance indicative of an occupant presence. The method includes configuring the electrode to have a diagnostic loop to provide an electrical conductivity indicative of a condition of the electrode. The method measures the electrical conductivity of the diagnostic loop and determines the condition of the electrode based on the electrical conductivity.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a perspective view of a vehicle seat assembly including an electrode for an occupant sensing system;

FIG. 2 is a block diagram of the occupant sensing system using the electrode shown in FIG. 1 and employing electrical fault detection according to one embodiment;

FIG. 3A is a top view of an electrode configuration according to a first embodiment;

FIG. 3B is a top view of an electrode configuration according to a second embodiment;

FIG. 3C is a top view of an electrode configuration according to a third embodiment; and

FIG. 4 is a flow chart illustrating a method to determine the condition of an electrode use with the fault detecting occupant sensing system shown in FIG. 2.

### DETAILED DESCRIPTION OF INVENTION

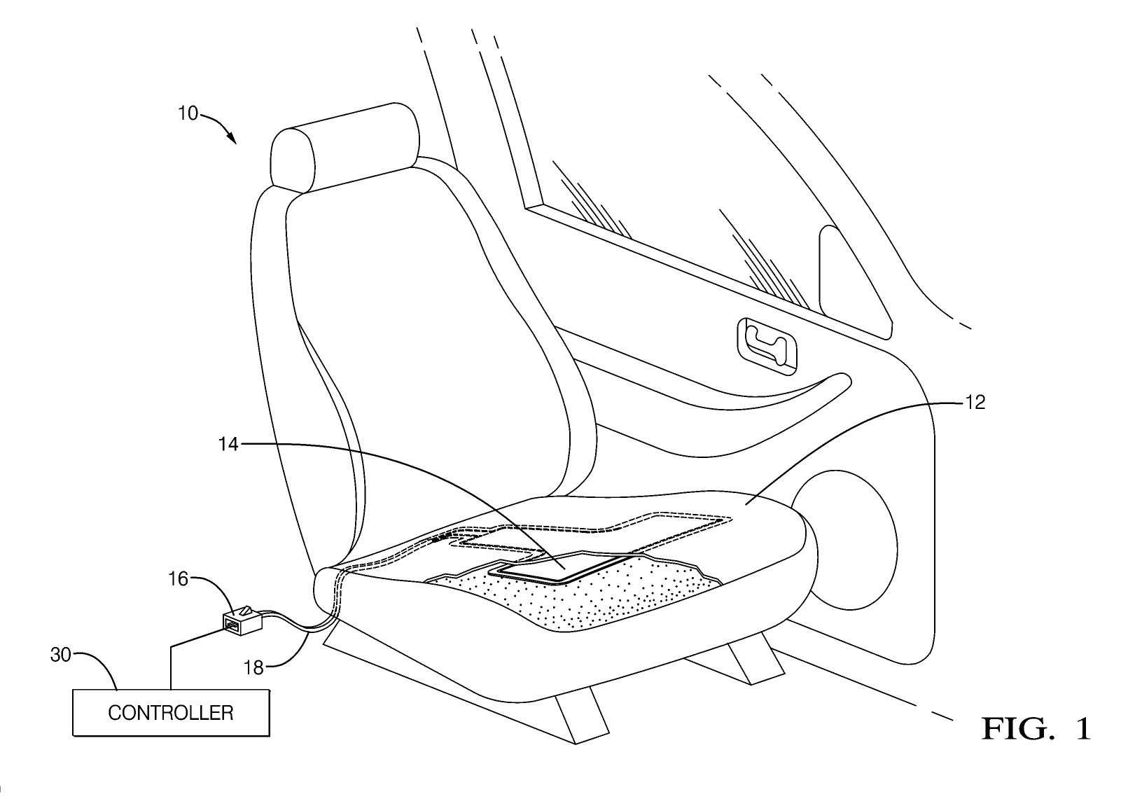

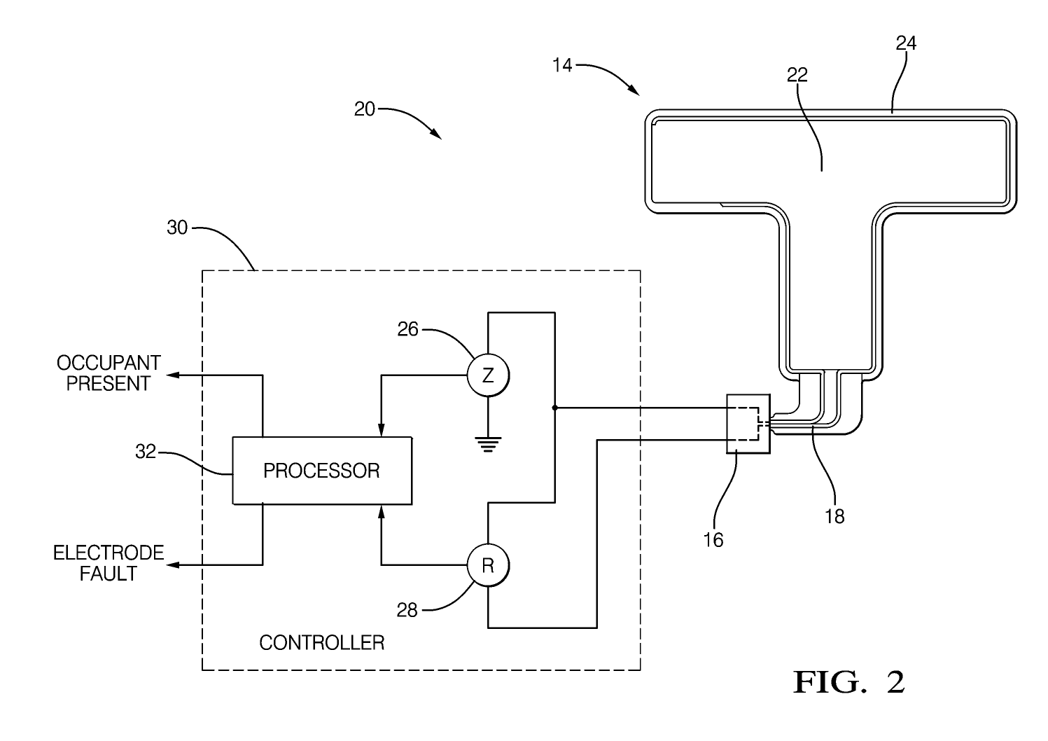

In accordance with an embodiment, FIG. 1 illustrates an exemplary seat assembly 10 providing a seating surface 12 suitable for supporting an occupant (not shown). The seat assembly 10 is illustrated in a vehicle passenger compartment, but could be used in any kind of vehicle, such as an airplane. The seat assembly 10 has an electrode 14 formed of electrically conductive material. Exemplary materials for forming the electrode 14 include metal wire, conductive fiber, metal foil, metal ribbon, and conductive ink. The electrode 14 is coupled to a controller 30 that is part of an occupant sensing system 20 illustrated in FIG. 2. In this embodiment, the electrode 14 is arranged to be located near or proximate to the seating surface 12. Such an arrangement improves occupant detection sensitivity and accuracy by the occupant sensing system 20. Coupling of the electrode 14 to the controller 30 may be by way of a connector 16 and leads 18. The leads 18 may be formed of the same conductive material as the electrode 14, or may be a wire harness originating at or near the main body of the electrode 14.

FIG. 2 illustrates an exemplary embodiment of the electrode 14 having an antenna portion 22 and a diagnostic loop portion 24. The antenna portion 22 is configured to provide an electrical electrode impedance indicative of the occupant presence for measurement by an impedance measuring device 26. When a signal, such as a sinusoidal waveform for example, is applied the electrode 14, an electric field is emitted that corresponds to the electrode impedance. As illustrated, the area of the antenna portion 22 occupies most of the electrode of the electrode 14, and so the antenna portion 22 radiates most of the electric field and so is a predominate influence on the electrode impedance. The antenna portion 22 corresponds to one plate of a capacitor and the frame and body of the vehicle around the seat assembly 10 corresponds to the other plate of the capacitor. It follows that the occupant corresponds at least in part to the dielectric material between the plates of the described capacitor. The presence or absence of an occupant correspondingly varies the dielectric constant of the material between the plates and thereby varies the electrical impedance of the electrode. As such, it is desirable to arrange the conductive material forming the electrode 14 to correspond to the area where an occupant will be in close proximity to the electrode 14, such as under the occupant's buttocks or thighs, and minimize the conductive material area where the electrode 14 is not in close proximity to the occupant, such as the leads 18. Minimizing the coverage area that is not in close proximity to the occupant minimizes the electric field coupling into the seat assembly 10, thereby maximizing the electrode impedance sensitivity to the occupant presence.

In one embodiment, the diagnostic loop portion 24 is configured to provide an electrical conductivity indicative of a condition of the electrode 14 for measurement by a conductivity measuring device 28. The diagnostic loop 24 is arranged so that areas or sites of conductive material forming the electrode 14 that are considered to be areas prone to damage are included in the diagnostic loop 24. For example, the area where the conductive material transitions from the leads 18 to the electrode 14 may be prone to fatigue damage for some seat assemblies. Measuring the conductivity of the diagnostic loop portion 24 may be useful to detect or indicate the likelihood of fractures or fatigue sites in the conductive material forming the electrode 14. The configuration and arrangement of the antenna portion 22 and the diagnostic loop portion 24 are selected based on testing of various configurations in various seat assemblies.

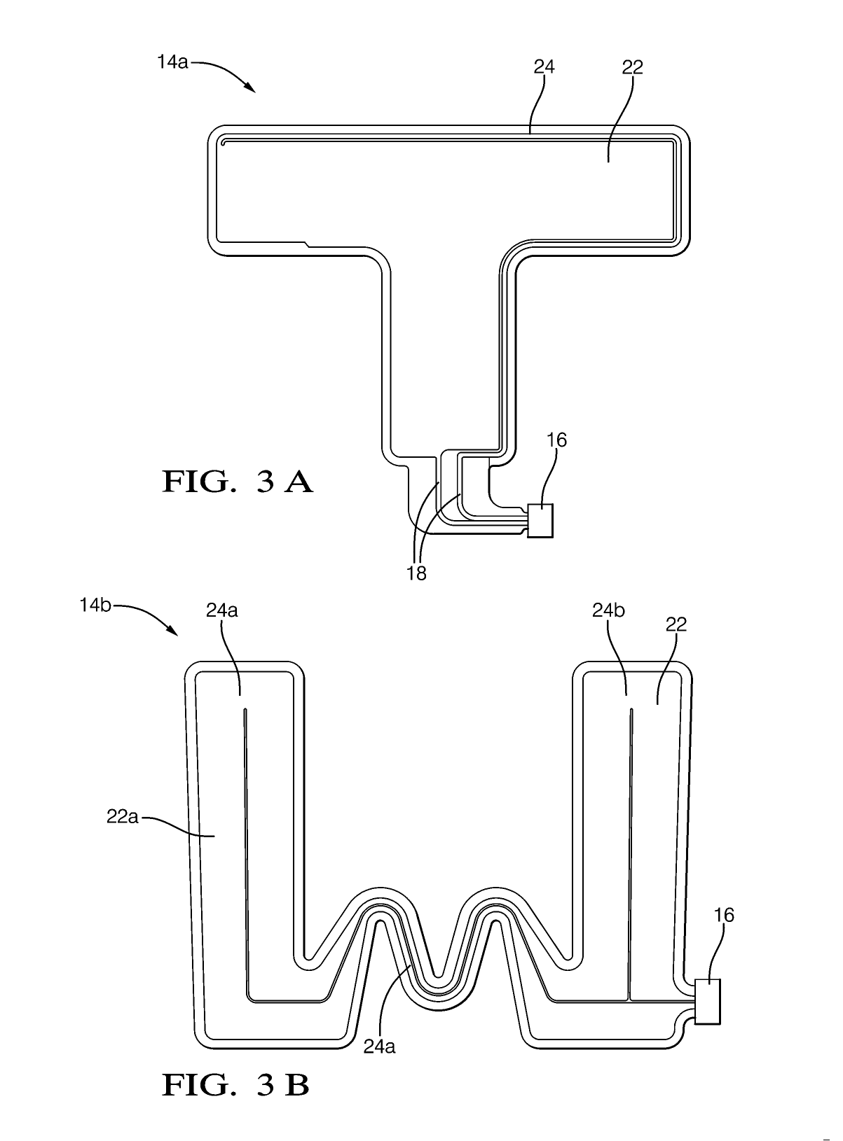

FIGS. 3A-C illustrate various embodiments of the electrode 14. The illustrations are oriented such that the edge of the electrode 14 that is towards the top of the sheet is the edge of the electrode 14 that is oriented towards the forward edge of the seating surface 12. Accordingly, the edge of the electrode 14 that is towards the bottom of the sheet is the edge of the electrode 14 that is oriented towards the backrest of seat assembly 10. As such, the electrode 14 is adapted for use in a vehicle seat.

FIG. 3A illustrates an exemplary embodiment of an electrode 14a having the diagnostic loop portion 24 arranged to substantially surround the antenna portion 22. The electrode 14a is illustrated having a T shape. The electrode 14a may be arranged in the seat assembly 10 such that the vertical section of the T is located under the occupant's buttocks. The horizontal section may be located to be about mid-thigh of an adult occupant and sized so the ends of the horizontal section extend under each thigh. It is believe that the T shape may be prone to fatigue along the top or forward edge of the electrode 14, so the diagnostic loop 24 is arranged such that the diagnostic loop is likely to be exposed to the fatigue that may provide an advanced indication of the onset of damage to the antenna portion 22.

FIG. 3B illustrates an another embodiment of an electrode 14b having a diagnostic loop portion and an antenna portion integrated such that the antenna portion comprises a first antenna region 22a and a second antenna region 22b interconnected by one or more of diagnostic loop regions 24a and 24b. The electrode 14b may be arranged in the seat assembly 10 such that antenna regions 22a and 22b are under the occupant's thighs. The diagnostic loop region 24a is illustrated having an M shape of parallel conductors. Such a shape may provide stress relief for the electrode 14b when the distance between antenna regions 22a and 22b varies due to occupants getting in and out of the seat assembly 10. The diagnostic loop region 24b may also provide for advanced detection of fractures of conductive material forming antenna regions 22a and 22b. The parallel conductors forming the diagnostic loop regions 24a and 24b are such that fractures in either area may be readily detected by measuring the diagnostic loop conductivity.

FIG. 3C illustrates another embodiment of an electrode 14c comprising a connector 16 for making electrical contact with the electrode 14c. A diagnostic loop portion 24c is arranged to be between the connector 16 and an antenna portion 22c. The electrode 14c includes conductive material in the form of a grid 14d underlying a reinforcement layer 14e. The reinforcement layer 14e may be suitably formed of polymer film or formed of woven or unwoven fabric. The reinforcement layer 14e may strengthen the electrode 14c such that the more complicated diagnostic loop features suggested in FIGS. 3A and 3B are less beneficial, but also adds expense to the electrode 14c. The electrode 14c may still be prone to fatigue damage where the leads 18 meet the electrode 14c, so the parallel conductor feature is used in this embodiment to detect fractures in that area.

Referring to FIG. 2, the occupant sensing system 20 includes a controller 30 coupled to the electrode 14 by way of the connector 16. The controller 30 may suitably include an impedance measuring device 26 and a conductivity measuring device 28. The controller 30 may also include a processor 32 adapted to receive a signal from the impedance measuring device 26 and determine the occupant presence based on the electrical impedance of the antenna portion 22. The processor 32 may also be adapted to receive a signal from the conductivity measuring device 28, and determine the condition of the electrode 14 based on the electrical conductivity of the diagnostic loop portion 24. The processor 32 may also be configured to determine that the electrode 14 is damaged based on the electrical conductivity. For example, if a time averaged conductivity is determined to be decreasing, or intermittent low conductivity conditions are detected, or an open circuit condition is detected, these conditions may indicate that the conductive material forming the electrode 14 has been damaged. Either time-averaged conductivity measurements or instantaneous conductivity measurements may be compared to various thresholds to make a determination as to the extent of any damage to the electrode 14. Commercially available microprocessors are available that can be configured to provide theses features.

An appropriate conductivity threshold for an embodiment of the electrode 14 is determined for each embodiment. If the conductivity threshold is too high, then electrode damage that may be properly characterized as insubstantial may prematurely indicate that the electrode is damaged. However, if the conductivity threshold is too low, then electrode damage that causes an occupant detection error may go undetected. By way of an example, an appropriate conductivity threshold may be 1.0 Mho, which is equal to the reciprocal of 1.0 Ohm.

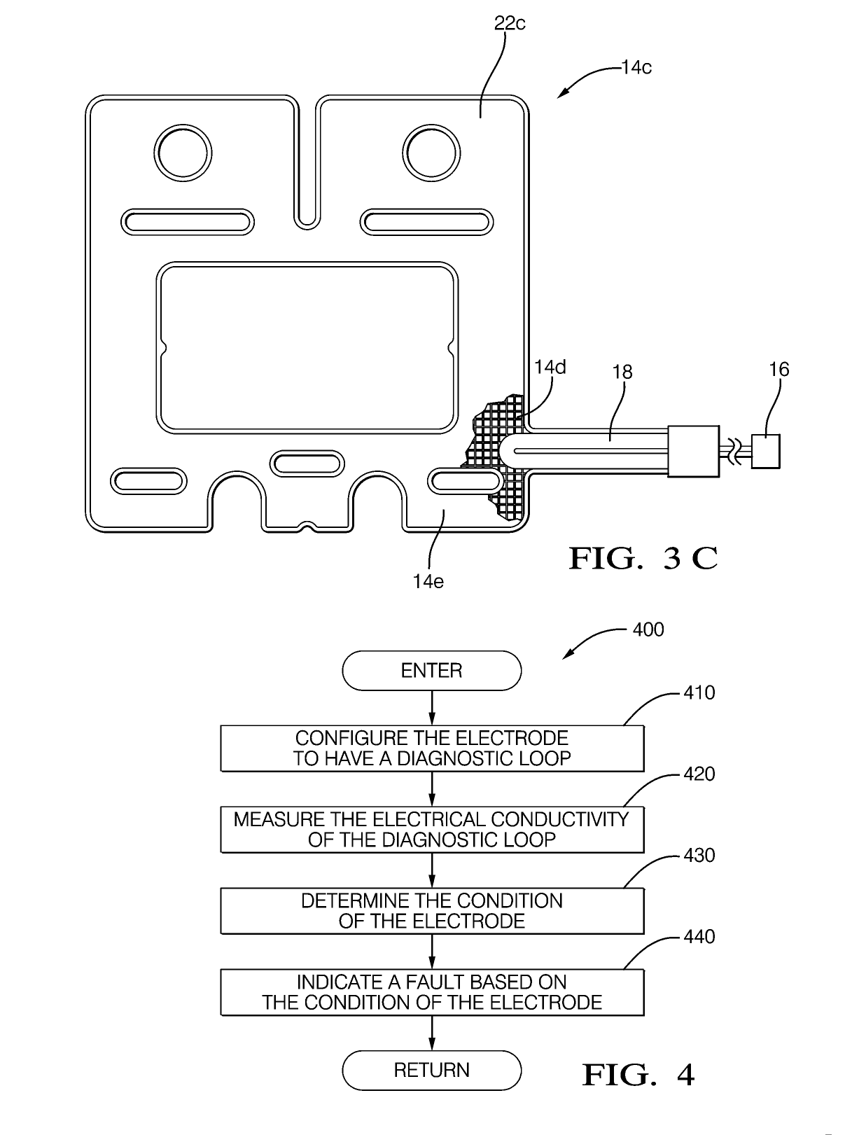

FIG. 4 illustrates a flowchart 400 of a method for detecting a fault in an occupant sensing system. At step 410, the electrode 14 is configured to have a diagnostic loop 24 to provide an electrical conductivity indicative of a condition of the electrode 14. At step 420, the controller 30 measures the electrical conductivity of the diagnostic loop 24. At step 430, the controller 30 determines the condition of the electrode 14 based on the electrical conductivity based on the electrical conductivity. At step 440, the controller outputs an indication of a fault based on the condition of the electrode. The indication of the fault may be an electrode fault signal generated by processor 32.

In another embodiment, a method of detecting a fault in an occupant sensing system may include the step of determining the condition of the electrode 14 by determining that the electrode 14 is damaged based on the electrical conductivity. For example, if the conductivity of the diagnostic loop 24 is below a threshold it may be an indication that the electrode 14 has been damaged to some degree. In another embodiment, a method of detecting a fault in an occupant sensing system may include the step of determining the condition of the electrode includes indicating an electrode fault when the electrical conductivity is less than a threshold. The indication of the electrode fault may be by way of turning on an indicator light on the vehicle instrument panel, or sending a message to a vehicle monitoring service such as On-Star.

Accordingly, an electrode suitable for use in an occupant sensing system is provided. The electrode is configured to have a diagnostic loop that provides a diagnostic loop conductivity for indicating that the electrode may be damaged. The diagnostic loop forms a portion of the electrode that is arranged such that damage to the electrode will affect the conductivity of the diagnostic loop such that damage to an antenna portion of the electrode may be indicated. Damage to the antenna portion may affect the accuracy of determining the presence of an occupant by an occupant sensing system and may not be detectable by measuring the electrode impedance.

While this invention has been described in terms of the preferred embodiments thereof, it is not intended to be so limited, but rather only to the extent set forth in the claims that follow.

We claim:

1. An electrode formed of electrically conductive material configured for use in an occupant sensing system, said electrode comprising:
an antenna portion configured to provide an electrical impedance indicative of an occupant presence; and
a diagnostic loop portion configured to provide an electrical conductivity indicative of a condition of the electrode.

2. The electrode in accordance with claim 1, further comprising a connector for making electrical contact with the electrode.

3. The electrode in accordance with claim 1, wherein the diagnostic loop portion is arranged to substantially surround the antenna portion.

4. The electrode in accordance with claim 1, wherein the diagnostic loop portion and the antenna portion are integrated such that the antenna portion comprises a first antenna region and a second antenna region interconnected by one or more diagnostic loop regions.

5. The electrode in accordance with claim 1, further comprising a connector for making electrical contact with the electrode, wherein the diagnostic loop portion is arranged between the connector and the antenna portion.

6. The electrode in accordance with claim 1, wherein the electrode is adapted for use in a vehicle seat.

7. An occupant sensing system having fault detection, said system comprising:
an electrode formed of electrically conductive material for sensing an occupant presence proximate thereto, said electrode comprising an antenna portion configured to provide an electrical impedance indicative of the occupant presence, and a diagnostic loop portion configured to provide an electrical conductivity indicative of a condition of the electrode; and
a controller coupled to the electrode, said controller configured to measure the electrical impedance to determine the occupant presence based on the electrical impedance and measure the electrical conductivity to determine the condition of the electrode based on the electrical conductivity.

8. The system in accordance with claim 7, wherein controller is further configured to determine that the electrode is damaged based on the electrical conductivity.

9. The system in accordance with claim 7, wherein the controller is further configured to indicate an electrode fault when the electrical conductivity is less than a threshold.

10. The system in accordance with claim 7, wherein the diagnostic loop portion is arranged to substantially surround the antenna portion.

11. The system in accordance with claim 7, wherein the diagnostic loop portion and the antenna portion are integrated such that the antenna portion comprises a first antenna region and a second antenna region interconnected by one or more diagnostic loop regions.

12. The system in accordance with claim 7, further comprising a connector for making electrical contact with the electrode, wherein the diagnostic loop portion is arranged between the connector and the antenna portion.

13. The system in accordance with claim 7, wherein the electrode is located in a vehicle seat.

14. A method of detecting a fault in an occupant sensing system comprising an electrode formed of electrically conductive material configured to provide an electrical impedance indicative of an occupant presence, said method comprising the steps of:
configuring the electrode to have a diagnostic loop to provide an electrical conductivity indicative of a condition of the electrode;
measuring the electrical conductivity of the diagnostic loop; and
determining the condition of the electrode based on the electrical conductivity.

15. The method in accordance with claim 14, further comprising:
indicating a fault based on the condition of the electrode.

16. The method in accordance with claim 14, wherein the step of determining the condition of the electrode includes determining that the electrode is damaged based on the electrical conductivity.

17. The method in accordance with claim 14, wherein the step of determining the condition of the electrode includes indicating an electrode fault when the electrical conductivity is less than a threshold.

18. The method in accordance with claim 14, wherein the electrode is located in a vehicle seat.
